(19) United States
(12) Patent Application Publication
(10) Pub. No.: US 2004/0201491 A1
(43) Pub. Date: Oct. 14, 2004

(54) Lamp set remote control system

(76) Inventor: Linsong Weng, Chu-Pei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/128,372

(22) Filed: Apr. 24, 2002

(51) Int. Cl. G08B 1/08; G08C 19/00

(52) U.S. Cl. 340/825.69

(57) ABSTRACT

A lamp set remote control system is constructed to include a handheld remote controller, which has a key module for signal entry, a first address-setting switch for setting address serial code, and a radio transmitter for transmitting a control signal by radio subject to the remote control signal from the key module and the address serial code signal from the first address-setting switch, and a lamp set control box, the lamp set control box having a radio receiver for receiving the control signal from the radio transmitter, an address comparator circuit for recognizing the address serial code of the control signal, and a lamp set control module, which controls flash of lamp sets connected thereto subject to the nature of the control signal from the remote controller.

### BACKGROUND OF THE INVENTION

1. Field of the Invention

The present invention relates lamp set control means and, more specifically, to a lamp set remote control system, which controls the flashing mode and the music tone and voice volume of multiple lamp sets by means of a remote controller.

2. Description of the Related Art

Following improvement of living standards, people pay more attention to the living environment around the houses. During festival or particular holidays, people may decorate houses and surrounding trees with decorative strings and lamp sets. More particularly, Christmas tree light sets are commonly used to decorate the inside as well as the outside of houses. A regular lamp set or Christmas tree light set is equipped with a control box, which controls the flashing mode of the lamp set or Christmas tree light set and the output of music tone. The control box has an electric plug for connection to an electric outlet. Connecting the electric plug to or disconnecting it from the electric outlet achieves the on/off control of the control box. The control box has keys for flashing mode control and music tone control. When multiple lamp sets or Christmas tree light sets are installed in different locations, it is inconvenient to control the operation of all installed lamp sets or Christmas tree light sets.

Following fast development of wireless remote control technology, it is practical to employ the technology to the control of lamp set control boxes.

### SUMMARY OF THE INVENTION

The present invention has been accomplished under the circumstances in view. It is one object of the present invention to provide a lamp set remote control system, which enables the user to control the flashing mode of multiple lamp sets and the matching music tone and voice volume by means of a remote controller. It is another object of the present invention to provide a lamp set remote control system, which enables the user to synchronously or selectively turn on/off multiple sets of lamp sets and, to selectively control the flashing mode of controlled lamp sets and/or the playing of music tone and voice volume. It is still another object of the present invention to provide a lamp set remote control system, which enables one remote controller to control multiple lamp set control boxes that control a respective set of lamp sets. To achieve these and other objects of the present invention, the lamp set remote control system comprises a handheld remote controller and at least one lamp set control box. The handheld remote controller comprises a key module for signal entry, a first address-setting switch for setting address serial code, and a radio transmitter for transmitting a control signal by radio subject to the remote control signal from the key module and the address serial code signal from the first address-setting switch. Each lamp set control box comprises a radio receiver for receiving the control signal from the radio transmitter, an address comparator circuit for recognizing the address serial code of the control signal, and a lamp set control module, which controls flash of lamp sets connected thereto subject to the nature of the control signal from the remote controller.

### BRIEF DESCRIPTION OF THE DRAWINGS

FIG. 1 is a circuit block diagram of a handheld remote controller for a lamp set remote control system according to the present invention.

FIG. 2 is a circuit block diagram of a lamp set control box for a lamp set remote control system according to the present invention.

### DETAILED DESCRIPTION OF THE PREFERRED EMBODIMENT

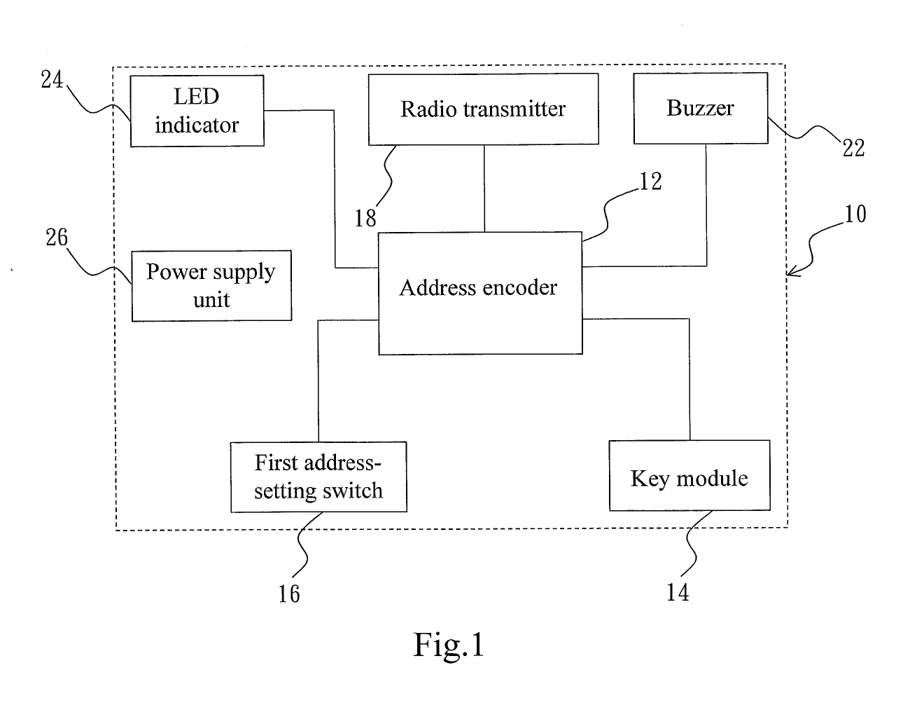

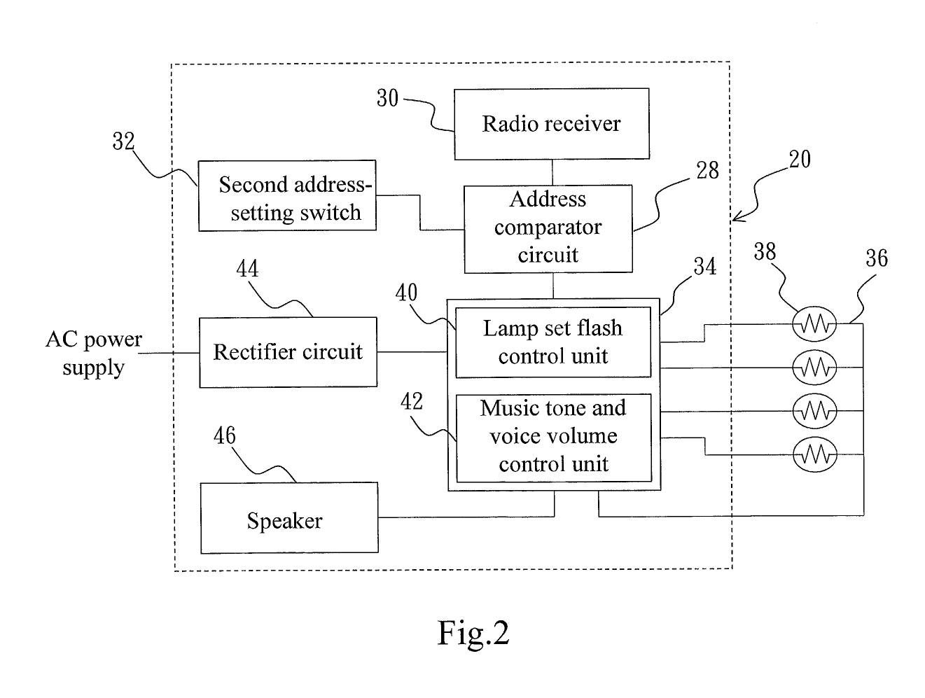

Referring to FIGS. 1 and 2, a lamp set remote control system in accordance with the present invention is comprised of a handheld remote controller 10 and a lamp set control box 20. The handheld remote controller 10 is comprised of an address encoder 12, a key module 14, a first address setting switch 16, a radio transmitter 18, and a power supply unit 26. The key module 14, the first address setting switch 16, and the radio transmitter 18 are respectively electrically connected to the address encoder 12. The address encoder 12 receives digital code signal from the key module 14, and drives the radio transmitter 18 to output a remote control signal to the lamp set control box 20 subject to the code signal from the key module 14 and the address serial code from the first address-setting switch 16. The power supply unit 26 provides the handheld remote controller 10 with the necessary working voltage. According to the present preferred embodiment, the power supply unit 26 is a battery. The lamp set control box 20 comprises an address comparator circuit 28, a radio receiver 30, a second address-setting switch 32, and a lamp set control module 34. The radio receiver 30, the second address setting switch 32, and the lamp set control module 34 are respectively electrically connected to the address comparator circuit 28. The lamp set control module 34 is connected to a number of external lamp sets 36. Each lamp set 36 is comprised of a plurality of different colors of lamps 38. The lamp set control module 34 comprises a flashing control unit 40 and a music tone and voice volume control unit 42, and is connected to AC power supply input end through a rectifier circuit 44. The rectifier circuit 44 rectifies AC power supply into DC power supply for the working of the lamp set control box 20. The lamp set control box 20 further comprises a speaker means 46 electrically connected to the lamp set control module 34. The radio receiver 30 receives remote control signal from the radio transmitter 18 of the handheld remote controller 10 for recognition by the address comparator circuit 28. After recognition of the address serial code of received remote control signal, the address comparator circuit 28 outputs a control signal to the lamp set control module 34, causing it to drive the flashing control unit 40 and/or the music tone and voice volume control unit 42 to control the operation of the lamp sets 36 and/or the speaker means 46.

The handheld remote controller 10 further comprises a buzzer 22 and a LED indicator 24 respectively electrically connected to the address encoder 12. Upon operation of the remote controller 10, the buzzer 22 buzzes, and the LED indicator 24 is turned on to give a visual signal. The integration of the flashing control unit 40 and the music tone and voice volume control unit 42 enables the lamp set control module 34 to control the flashing mode of the lamp sets 36 and music tone and voice volume outputted through the speaker means 46. The key module 14 of the handheld remote controller 10 comprises different function keys for different function control so that the user can selectively control the operation of the lamp sets 36 and the output of music tone and voice volume.

Further, the design of the address-setting switches 16;32 in the remote controller 10 and lamp set control box 20 enables the user to set the address serial code of the lamp set control box 20 subject to that of the remote controller 10. Therefore, the invention enables a number of lamp set control boxes to be used with a remote controller to control multiple sets of lamp sets that are respectively connected to the control boxes at different locations.

As indicated above, the lamp set remote control system enables the user to control multiple sets of lamp sets and music playing modes through a single remote controller.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A lamp set remote control system comprising:
a remote controller, said remote controller comprising a key module for signal entry, a radio transmitter, a first address-setting switch adapted to set address serial code, an address encoder adapted to receive digital code signal from said key module and to drive said radio transmitter to output a remote control signal to a lamp set control box subject to the code signal from said key module and the address serial code from said first address-setting switch, and a power supply unit, which provides the handheld remote controller with the necessary working voltage; and
at least one lamp set control box adapted to control the operation of lamp sets connected thereto subject to the remote control signal from said remote controller, said at least one lamp set control box each comprising a radio receiver adapted to receive remote control signal from said remote controller, a second address-setting switch adapted to set address serial code subject to the address serial code of said remote controller, an address comparator circuit adapted to compare the address serial code of remote control signal received by said radio receiver with the address serial code set by said second address-setting switch and to output a corresponding control signal, a lamp set control module adapted to receive control signal from said address comparator circuit and to control the operation of lamp sets connected thereto subject to received control signal, and a rectifier circuit adapted to convert AC power supply into DC power supply for the working of the respective lamp set control box.

2. The lamp set remote control system as claimed in claim 1, wherein said remote controller further comprises a buzzer and a visual indicator means respectively electrically connected to said address encoder and adapted to provide audio and visual signals respectively upon operation of key module.

3. The lamp set remote control system as claimed in claim 1, wherein said at least one lamp set control box each further comprises speaker means electrically connected to the lamp set control module of the respective lamp set control box for voice output.

4. The lamp set remote control system as claimed in claim 1, wherein the lamp set control module of each of said at least one lamp set control box comprises a flashing control unit adapted to control flashing of lamp sets connected thereto, and a music tone and voice volume control unit adapted to control audio output through speaker means of the respective lamp set control box.
